(19) United States
(12) Patent Application Publication
(10) Pub. No.: US 2023/0066026 A1
(43) Pub. Date: Mar. 2, 2023

(54) Device for stabilizing video equipment

(71) Applicant: Anton Yanovich RADZEVICH, Moscow (RU)

(72) Inventor: Anton Yanovich RADZEVICH, Moscow (RU)

(21) Appl. No.: 17/799,939

(22) PCT Filed: Feb. 17, 2021
(86) PCT No.: PCT/RU2021/050039

§ 371 Date: Aug. 16, 2022

(30) Foreign Application Priority Data
Feb. 17, 2020 (RU) 2020107183

(51) Int. Cl. H04N 5/232

(52) U.S. Cl. CPC H04N 5/23287

(57) ABSTRACT

The invention relates to handheld devices for stabilizing film and video recording equipment (film cameras, video cameras and other recording devices), which compensate for shaking and vibrations from the hands or shoulder of the operator when filming in motion and allow the smooth movement of video equipment. A device for stabilizing video equipment comprises a base and a movable platform connected to one another by at least one hinge mechanism that is configured on the basis of the relationship expressed in formula (I), where x is the distance from the upper horizontal surface of the platform to the point of intersection of the axes of a hinge mechanism; K≤0.5; Vi=ai×bi×ci; ai is the length of a three-dimensional parallelepiped; bi is the height of a three-dimensional parallelepiped; ci is the width of a three-dimensional parallelepiped; n is the total number of hinge mechanisms. The technical result lies in reducing the dimensions and weight of the stabilizing device.

### FIELD OF THE INVENTION

The invention relates to manual devices for stabilizing equipment for cinema and video recording (movie cameras, video cameras and other shooting devices), compensating for shaking and vibrations when shooting in motion with hands or from the operator's shoulder, providing smooth movement of video equipment.

### BACKGROUND OF THE INVENTION

At the heart of all the technical solutions used in the film industry for stabilizing movie cameras is a device that allows the camera, or the camera, together with a counterweight, to rotate around the center of gravity of this device. Such devices simultaneously solve two problems: compensation for unwanted angular turns, that is, it provides stabilization, and they are also used for horizontal and vertical panning of the camera.

Gymbal-type devices are known in the art for stabilizing camcorders and cameras with a video recording function that the operator can carry in his hands. Such cameras are balanced in the center of the system, where they can rotate freely in three axes. Degrees of freedom are used both for stabilization and for panning.

For example, from US 2018335178 A1, publ. Nov. 22, 2018, a stabilization device is known that includes a payload stabilization unit, handles configured so that the user can fully support the stabilizing device. The node stabilization of the payload is made with the possibility of supporting the payload and ensuring, with the help of articulated joints, the possibility of free rotation of the stabilized object in three axes, made orthogonal to each other.

The disadvantages of this device include the inability to work with large cameras, uncomfortable ergonomics and controls (the operator holds the system outstretched arms), the large dimensions and weight of the device.

Also, from WO 2019134151 A1, publ. Jul. 11, 2019, a manual stabilization device is known that contains a suspension mechanism, a platform on which a stabilized object is mounted, a handle connected to the suspension, while the suspension mechanism is rotatable around three axes using articulated joints.

The disadvantage of this solution is that such mechanics are not scaled in such a way that it would be possible to build a similar system for larger cameras. This is due to the fact that despite the small absolute size of the system, it is quite large compared to the size of the camera.

### DISCLOSURE OF INVENTION

The technical task of the present invention is to provide a device capable of stabilizing video equipment and film equipment during the shooting during its movement, while having small dimensions and weight.

The technical result is to reduce the size and weight of the stabilization device.

The technical result is achieved due to the fact that the stabilization device of the video equipment contains a base and a movable platform interconnected by at least one articulated mechanism, based on the following ratio:

$$\frac{{\sum }_{i = n}^{i = 1} {V}_{i}}{8 {x}^{3}} = K \\ \frac{{\sum }_{i = n}^{i = 1} {V}_{i}}{8 {x}^{3}} = K$$

where x is the distance from the upper horizontal plane of the platform to the point of intersection of the axes of the articulated mechanism;

K is the resulting coefficient (K≤0.5);

Vi is the volume of each of the parallelepipeds in which the hinge mechanism is enclosed (Vi=ai×bi×ci);

ai is the length of the dimensional parallelepiped;

bi is the height of the overall parallelepiped;

ci is the width of the overall box;

n is the total number of articulated mechanisms.

The hinge mechanism is at least two links connected both to each other and to the base and platform, using at least three cylindrical hinges, each of which is rotatable around its axis.

The first link with its first end is connected to the base of the device, and its second end is connected to the first end of the second link, while the second end of the second link is connected to the platform of the device.

The axis of the articulated mechanisms are not orthogonal to each other.

The device contains more than one articulated mechanism, and the axes of all articulated mechanisms intersect at one point.

The device may further comprise at least one brushless motor that is mounted directly on the axis or configured to control the hinges through at least one lever, belt or chain drive.

The device may further comprise adjustable handles and interchangeable shoulder rests attached to the base of the device.

The device may further comprise a monitor and/or sight, which are attached to the base and/or to a movable platform or brought to the camera or body of the operator.

The device may further comprise an internal or external battery pack configured to power the device and the camera to be stabilized.

### BRIEF DESCRIPTION OF THE DRAWINGS

FIG. 1—General view of an embodiment of a stabilization device;

FIG. 2—Stabilization device, bottom view;

FIG. 3—articulated mechanism;

FIG. 4—Stabilization device, side view.

FIG. 5—Stabilization device, bottom view.

FIG. 6—Stabilization device with a movie camera installed.

### IMPLEMENTATION OF THE INVENTION

The objective of the claimed solution is to create a device that, in comparison with the solutions known from the prior art, has small dimensions, weighing due to the fact that it carries only the stabilization function, since when shooting from a handheld camera, the operator performs panning by rotating the housing and tilt your hands.

It should be understood that in all known stabilization systems mentioned above, the following ratio of its elements exists:

$$\frac{{\sum }_{i = n}^{i = 1} {V}_{i}}{8 {x}^{3}} = K \\ \frac{{\sum }_{i = n}^{i = 1} {V}_{i}}{8 {x}^{3}} = K$$

where, x is the distance from the upper horizontal plane of the platform to the point of intersection of the axes of the hinge mechanism (respectively, 8x³ is the volume of the cube, with the center coinciding with the point of intersection of the axes of the hinge mechanisms, and in contact with its face with the movable platform);

K is the resulting coefficient;

Vi=ai×bi×ci;

ai is the length of the dimensional parallelepiped (volumetric quadrangle);

bi is the height of the overall parallelepiped;

ci is the width of the overall box;

n is the total number of articulated mechanisms.

It should be understood that such an equality can be made for all of the above systems, and similar ones, but in existing systems, the coefficient K is much more than 0.5.

In this case, the actual dimensions of the device are the smaller, the smaller the resulting coefficient K.

In actually existing solutions, the coefficient K is greater than 1, as a result of which the dimensions of the known systems are quite large, and with the implementation of the kinematics used in existing systems, reducing the coefficient is extremely difficult.

The aim of the claimed invention is to reduce the size of the stabilization device by obtaining a lower coefficient K.

To reduce the dimensions of the stabilization device, it was decided to change its mechanics, namely: to change the location of the hinge mechanisms, to reduce the angles between the axes of each link of the hinge mechanism, so that as a result they fit into a much smaller overall box, resulting in a decrease in the K coefficient in the above formula.

The mechanics of the claimed device is sufficient to ensure freedom of rotation of the camera only within a few degrees, sufficient for stabilization. The ability to rotate the camera 360 degrees is needed only for panning, not stabilization, but because of this, a system that can rotate all 360 degrees is much larger in size and weight than a system that can rotate only a few degrees.

Such a device will have different performance characteristics compared to existing systems, namely, a smaller range of rotation of the stabilized platform relative to the base.

It should be understood that the larger the K coefficient, the more overall the system becomes, but at the same time, the range of stabilized deviations is greater, that is, it is possible to work in more severe conditions, and the range of stabilized deviations is greater. And as the coefficient K decreases, the system becomes more compact, but at the same time, the range of operation of the hinge mechanism decreases.

It was experimentally established that with a decrease in the range of operation of the hinge mechanisms, with a coefficient of K equal to 0.5 or less, it was possible to achieve a significant reduction in the dimensions of the device, and with a coefficient of K from 0.5 to 1.0, the same significant decrease in size was not achieved.

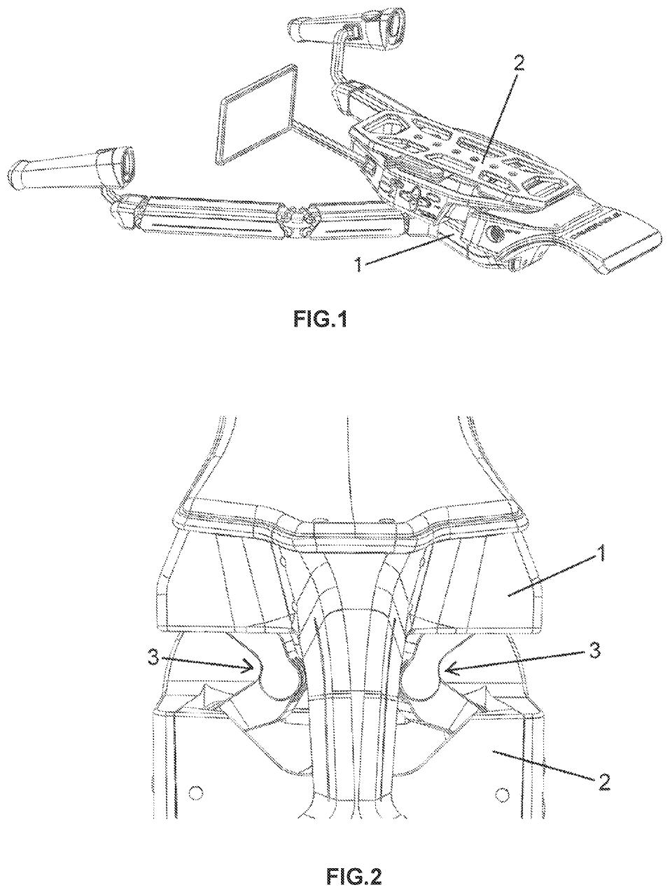

The video equipment stabilization device contains (see FIG. 1,2) a base 1 and a movable platform 2, interconnected by at least one articulated mechanism 3, based on the following ratio:

$$\frac{{\sum }_{i = n}^{i = 1} {V}_{i}}{8 {x}^{3}} = K \\ \frac{{\sum }_{i = n}^{i = 1} {V}_{i}}{8 {x}^{3}} = K$$

where, x is the distance from the upper horizontal plane of the platform to the point of intersection of the axes of the hinge mechanism (respectively, 8x³ is the volume of the cube, with the center coinciding with the point of intersection of the axes of the hinge mechanisms, and in contact with its face with the movable platform);

K is the resulting coefficient (K≤0.5);

Vi is the volume of each parallelepiped in which the hinge mechanism is enclosed (Vi=ai×bi×ci);

ai is the length of the dimensional parallelepiped (volumetric quadrangle);

bi is the height of the overall parallelepiped;

ci is the width of the overall box;

n is the total number of articulated mechanisms.

The base of the device can be of any shape, with the possibility of holding it by the operator in his hands, both at a distance from the body of the operator (on outstretched arms), and near the body or on the shoulder of the operator.

The platform 2 is located on top of the base 1, designed to install video equipment on it, connected to the base using a hinge mechanism 3.

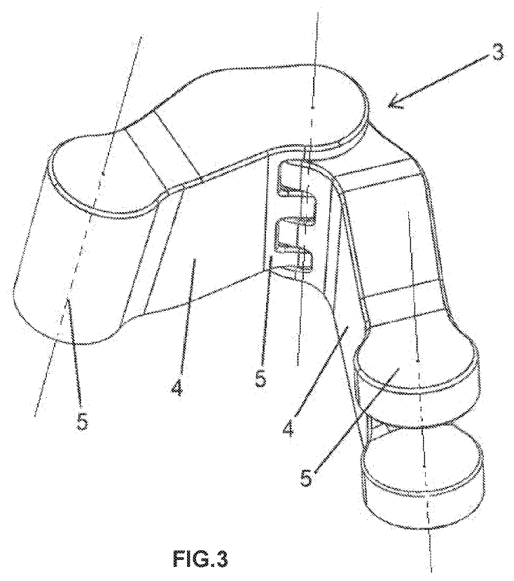

The hinge mechanism 3 is (see FIG. 3) at least two links 4 connected both to each other and to the base 1 and the platform 2, using at least three cylindrical hinges 5, each of which made with the possibility of rotation around its axis. The first link at its one end is pivotally connected to the base 1 of the device, and the second end is pivotally connected to the other link, while the second end of the second link is pivotally connected to the platform 2 of the device.

The hinge mechanism, having at least two links pivotally connected between each other and with the base and platform, contains at least three cylindrical hinge joints, the axis lines of which are not orthogonal to each other. These axes intersect at one point located at a distance X from the platform. The location of the hinge axes in space is selected in such a way as to ensure the mobility of the stabilized platform in three rotational degrees of freedom. It should be understood that if more than one hinge is used in the system, then all the axes of all hinges must intersect at one point.

To make the system more compact, at least three axes that create degrees of freedom of rotation of the camera are not located orthogonally to each other, but at a smaller angle, for example, 10-20 degrees, which is sufficient to stabilize the camera, but the device at least two times less devices that provide a full turn, and, accordingly, several times lighter.

As in competing systems, mechanics can be driven by brushless motors (or other types of motors).

Since the rotation axes do not coincide with the traditional orthogonal axes X, Y and Z, a special algorithm must be built into the device that calculates the rotation coefficients of the engines to achieve correct stabilization.

At the same time, at least one engine can be mounted either directly on the axis or on any other suitable device location with the possibility of controlling the hinges through at least one lever, belt or chain drive, or other mechanical connection.

The stabilization device may include adjustable handles, interchangeable variations of the shoulder rests attached to the base of the device, and other auxiliary elements, for more convenient holding the device by the operator.

In addition, the device may include a monitor and/or a sight and/or other shooting accessories that can be attached to both the base and the movable platform, or can be brought to the camera or the body of the operator.

The device can be powered from both internal and external battery packs located on the operator's body. At the same time, a stabilized camera can also be powered from this battery pack.

An example implementation of the claimed invention.

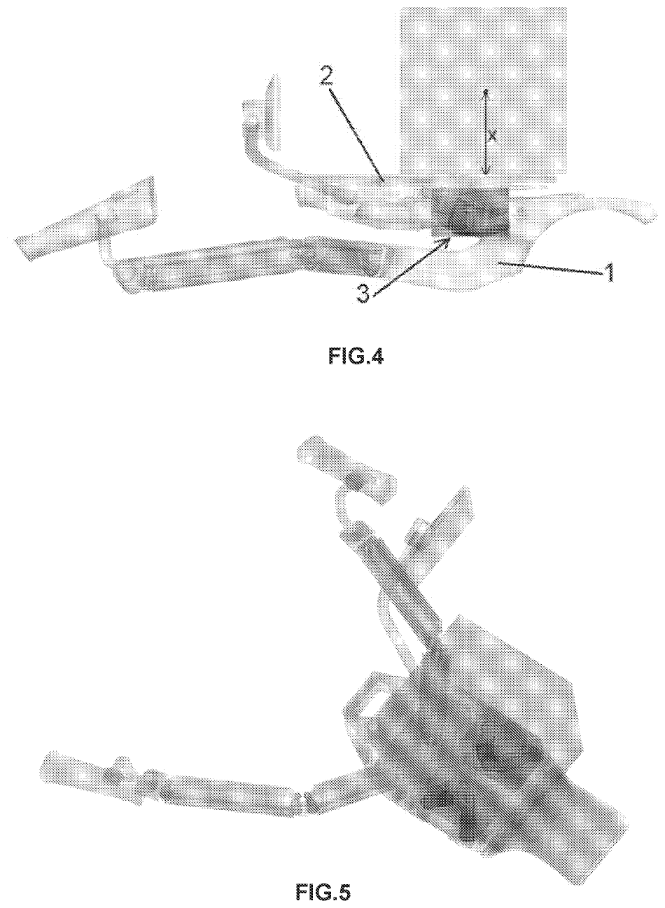

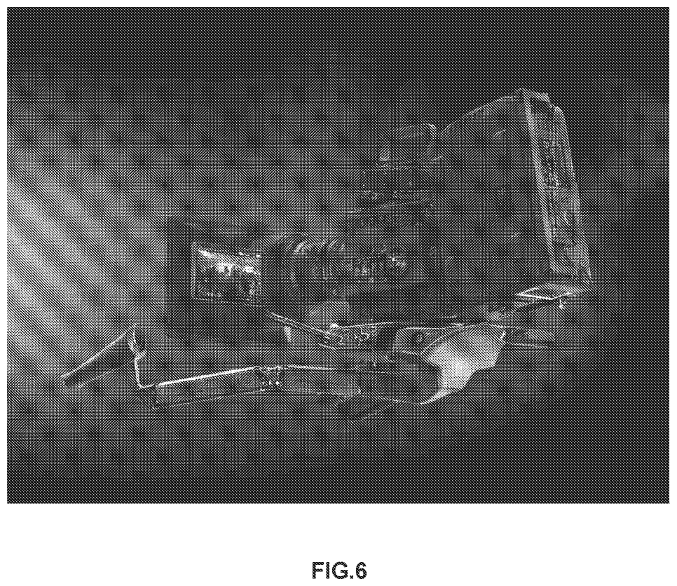

The stabilization device contains a base and a movable platform, interconnected by two articulated mechanisms (FIG. 4-6).

A stabilized object (for example, a movie camera) is installed on the platform, whose “body” (that is, not taking into account, for example, the battery pack, interchangeable lens, etc.) is enclosed in a virtual dimensional cube. The cube side in this example is 150 mm.

The distance from the upper horizontal plane of the platform to the point of intersection of the axes of the articulated mechanism is 75 mm.

Each articulated mechanism enclosed in a virtual dimensional parallelepiped has a volume corresponding to its overall dimensions—the length of the parallelepiped is 70 mm, its width is 53 mm, and its height is 44 mm.

The hinge mechanism is based on the following ratio:

$$\frac{{\sum }_{i = n}^{i = 1} {V}_{i}}{8 {x}^{3}} = K \\ \frac{{\sum }_{i = n}^{i = 1} {V}_{i}}{8 {x}^{3}} = K$$

In the proposed example, the coefficient K is equal to 0.097.

Moreover, the range of rotation of the platform relative to the base is 20, 10 and 10 degrees around the horizontal, vertical and longitudinal axes, respectively.

A number of different cameras can be installed on this stabilization device, the height of the center of gravity of such a camera should not exceed the value of X. The camera is installed so that its center of gravity is as close as possible geometrically to the point of intersection of the axes of the hinge mechanisms.

As mentioned earlier, the construction of the articulated mechanism is at least two links connected both to each other and to the base and platform, using at least three axes that provide rotation. The bearing part of the hinge mechanism is the part connecting the two axes and providing rigidity between them.

At the same time, the addition of any elements to this construct or changes in the shape of existing ones that do not increase, at the same time, the bearing capacity of the mechanism and necessary only to increase its volume, should not be taken into account when calculating the above volumes. That is, when the volume of the parallelepipeds ai×bi×ci in which the hinges are enclosed is considered, then only the part of the hinge that actually carries the load lies inside the parallelepipeds.

The claimed invention provides stabilization of video equipment during the shooting during movement, but it has much smaller dimensions and weight compared to known similar solutions.

1. A device for stabilizing video equipment comprising a base and a movable platform interconnected by at least one hinge mechanism, made on the basis of the following ratio:
$$\frac{{\sum }_{i = n}^{i = 1} {V}_{i}}{8 {x}^{3}} = K$$
where x is the distance from the upper horizontal plane of the platform to the point of intersection of the axes of the hinge mechanism;
K<0.5;
Vi=ai×bi×ci; ai is the length of the overall parallelepiped; bi is the height of the overall parallelepiped; ci is the width of the overall parallelepiped; n is the total number of hinge mechanisms.

2. The device for stabilizing video equipment according to claim 1, wherein the hinge mechanism is at least two links connected both to each other and to the base and the platform by means of at least three cylindrical hinges, each of which it is made with the possibility of rotation around its axis.

3. The device for stabilizing video equipment according to claim 2, wherein the first link is connected with its first end to the base of the device, and its second end is connected to the first end of the second link, while the second end of the second link is connected to the platform of the device.

4. The device for stabilizing video equipment according to claim 1, wherein the axes of the hinge mechanisms are not orthogonal to each other.

5. The device for stabilizing video equipment according to claim 1, wherein it contains more than one hinge mechanism, and the axes of all hinge mechanisms intersect at one point.

6. The device for stabilizing video equipment according to claim 1, wherein it further comprises at least one brushless motor, which installed directly on the axle, or made with the ability to control the hinges through at least one lever, belt or chain transmission.

7. The device for stabilizing video equipment according to claim 1, further comprising adjustable handles and replaceable shoulder rests attached to the base of the device.

8. The device for stabilizing video equipment according to claim 1, wherein it further comprises a monitor and/or a sight, which are attached to the base and/or to the movable platform, or placed on the camera or the operator's body.

9. The device for stabilizing video equipment according to claim 1, further comprising an internal or external battery pack capable of powering the device and the camera to be stabilized.
